(19) United States
(12) Patent Application Publication
(10) Pub. No.: US 2025/0051897 A1
(43) Pub. Date: Feb. 13, 2025

(54) NI-NB-CU ALLOY METALLIC GLASSES

(71) Applicant: VULKAM, Gières (FR)

(72) Inventors: Alexis LENAIN, La Tronche (FR); Léna VERCHÈRE, La Tronche (FR)

(73) Assignee: VULKAM, Gières (FR)

(21) Appl. No.: 18/717,602

(22) PCT Filed: Dec. 6, 2022
(86) PCT No.: PCT/EP2022/084569

§ 371 Date: Jun. 7, 2024

(30) Foreign Application Priority Data
Dec. 7, 2021 (FR) FR2113043

(51) Int. Cl. C22C 45/04; C22C 1/11

(52) U.S. Cl. CPC C22C 45/04; C22C 1/11

(57) ABSTRACT

A metallic glass formed of an alloy including: (a-c-x) atomic % of Ni, with a between 54 and 72; (b-y) atomic % of Nb, with b between 35 and 44; c atomic % of Cu, with c from 0.05 to 9; x atomic % of at least one element chosen from: Co, Fe, Ag, Mn, Pd, Au, Ir, Os, Pt, Re, Rh, Ru and Te, with x from 0 to 20; y atomic % of at least one element chosen from: Hf, Ta, Ti, Cr, Mo, Sc, V, W and Y, with y from 0 to 20; z atomic % of at least one element chosen from: B, Si, Al, Sn, Ca, Ga, In, Mg and Zn, with z from 0 to 10; at most 3 atomic % of Zr; and other elements at most 0.1% by weight each and at most 0.5% by weight in total.

### TECHNICAL FIELD

The invention concerns new nickel-niobium-copper (Ni—Nb—Cu) alloy metallic glasses, more particularly such Ni—Nb—Cu alloy metallic glasses comprising little or no zirconium and having improved properties.

### PRIOR ART

The “Amorphous metallic alloys” (AMAs) or “metallic glasses” have exceptional mechanical properties compared to their traditional crystalline counterparts: high elastic limit and hardness, high elastic deformation capacity, high resistance to fatigue, corrosion and abrasion. Long limited by manufacturing methods inducing geometries not very inclined to industrialization, AMA parts may now be obtained industrially via in particular a method comprising two successive steps: (i) the melting of a set of pure metal ingots defining the composition of the final material then, (ii) the extremely rapid cooling of the liquid mixture resulting in a solidification without the formation of crystals or, at the very least, whose amorphous phase predominates compared to the crystalline phase. This method may then make it possible to produce parts of centimeter size with sub-micrometric geometric details and very high form factors, even in the absence of subsequent machining operation.

The unprecedented properties of AMAs have naturally aroused a great interest in the design of parts subjected to high mechanical stresses and/or to tribological contacts, and therefore to significant friction and wear. This interest is now growing due to the need to miniaturize the mechanical systems in many sectors, particularly those of watchmaking and the medical field, which in particular leads to sliding, rolling speeds, as well as contact pressures increasingly restrictive.

However, AMAs are complex to elaborate and may therefore have scattered mechanical behaviors that are sometimes unpredictable. In particular, it has been observed during the melting of the metals of NiNbZr alloy systems, especially when nickel is present in large quantities compared to zirconium, that an oxide skin appears on the surface of the material. This oxide skin is not a priori present in any other alloy system; this has never been observed for the alloys based on Zr, Cu, Ti or Hf. This oxide skin consists of Zr oxides. These oxides constitute metallurgical defects which are found at the heart of the material. Thus, these alloys have a non-reproducible mechanical behavior as the oxides tend to weaken the part. From an industrial advantage point of view, there is therefore a real technical interest in minimizing or even eliminating zirconium in the NiNb amorphous alloy systems.

However, the difficulty of AMAs also lies in the complex elaboration of their composition, each element interacting with others and this in a different way depending on the content of each of these so-called alloy elements.

### Technical Problem

The known solutions do not make it possible to obtain a NiNb alloy having both a reproducible mechanical behavior, an excellent compromise of mechanical properties, in particular in terms of compromise between their elastic limit and their elastic deformation capacity, as well as an excellent processability, essential for the industrialization of the parts made of high-speed AMAs.

There is therefore a need for a new NiNb alloy system in order to solve the problems exposed above.

### DISCLOSURE OF THE INVENTION

The aim of the present invention is a metallic glass formed from an alloy comprising:
(a-c-x) atomic percent of Ni, with a comprised between 54 and 72;
(b-y) atomic percent of Nb, with b comprised between 35 and 44;
c atomic percent of Cu, with c from 0.05 to 9;
x atomic percent of at least one element chosen from: Co, Fe, Ag, Mn, Pd, Au, Ir, Os, Pt, Re, Rh, Ru and Tc, preferably chosen from: Co, Fe, Ag, Mn and Pd, more preferably chosen from: Co and Fe, with x from 0 to 20;
y atomic percent of at least one element chosen from: Hf, Ta, Ti, Cr, Mo, Sc, V, W and Y, preferably chosen from: Hf, Ta and Ti, more preferably chosen from: Hf and Ti, with y from 0 to 20;
z atomic percent of at least one element chosen from: B, Si, Al, Sn, Ca, Ga, In, Mg and Zn, preferably chosen from: B, Si and Al, more preferably Al, with z from 0 to 10;
at most 3 atomic percent of Zr;
other elements not more than 0.1% by weight each and not more than 0.5% by weight in total.

There is also proposed a part made of metallic glass as previously described, in particular a timepiece or a part for medical use.

There is further proposed a method for manufacturing a part made of metallic glass as described above comprising the following steps:
melting a mixture of metals to obtain an alloy,
casting the obtained alloy in a mold, and
cooling the cast alloy with a cooling rate greater than a critical crystallization rate of the alloy, to obtain an amorphous alloy preform or a part made of amorphous alloy,
optionally, thinning the obtained preform to obtain a thinned amorphous alloy preform or a part made of amorphous alloy,
optionally, machining the amorphous alloy preform, possibly thinned, preferably by laser cutting, turning, electro-erosion and/or thermoforming, to obtain a part made of amorphous alloy according to a predetermined geometry,
optionally, carrying out a step of finishing the part made of amorphous alloy.

The characteristics exposed in the following paragraphs may, optionally, be implemented. They may be implemented independently of each other or in combination with each other.

According to an advantageous embodiment, the metallic glass comprises (a-c-x) atomic percent of Ni, with a from 58 to 66, preferably from 60 to 64, more preferably from 61 to 63.

According to another embodiment, the metallic glass comprises (b-y) atomic percent of Nb, with b from 35 to 42, preferably from 36 to 41, more preferably from 37 to 39.

Advantageously, the metallic glass comprises c atomic percent of Cu, with c from 0.05 to 8, preferably from 0.5 to 6, more preferably from 1 to 4.

Preferably, the metallic glass comprises x atomic percent of at least one element chosen from Co, Fe, Ag, Mn, Pd, Au, Ir, Os, Pt, Re, Rh, Ru and Tc, with x from 0.5 to 10, preferably from 1 to 6, more preferably from 1 to 5 and even more preferably from 1 to 3.

According to one embodiment, the metallic glass comprises y atomic percent of at least one element chosen from: Hf, Ta, Ti, Cr, Mo, Sc, V, W and Y with y from 0.5 to 10, preferably from 1 to 8, more preferably from 1 to 5 and even more preferably from 1 to 3.

According to another embodiment, the metallic glass comprises z atomic percent of at least one element chosen from: B, Si, Al, Sn, Ca, Ga, In, Mg and Zn, with z from 0 to 8, preferably from 0.5 to 8, more preferably from 1 to 5 and even more preferably from 1 to 3.

Advantageously, the metallic glass comprises less than 3 atomic percent of Zr, preferably less than 2, more preferably less than 1, even more preferably than 0.5 or even less than 0.05. According to one embodiment, the Zr is not intentionally added to the alloy and, if it is present as an impurity, its content is that of the other elements as detailed below.

The metallic glass may comprise elements that were not intentionally added to the alloy. Such elements correspond to impurities included for example in the primary elements or resulting from the manufacturing method. Although it is sought to minimize such impurities as much as possible, the metallic glass may therefore comprise other elements whose content is at most 0.1% by weight each and at most 0.5% by weight in total. More preferably, this content is, in weight percent, at most 0.05 each and at most 0.2 in total. Preferably, the alloy comprises less than 250 ppm (parts per million) by weight, more preferably less than 200 ppm by weight and even more preferably less than 150 ppm by weight of each of these impurities.

Preferably, the metallic glass is formed from an alloy selected from: Ni₆₁Nb₃₈Cu₁, Ni₆₀Nb₃₈Cu₂, Ni₅₉Nb₃₈Cu₃, Ni₅₈Nb₃₈Cu₄, Ni₅₆Nb₃₈Cu₆, Ni₅₄Nb₃₈Cu₈, Ni₅₅Nb₄₂Cu₃, Ni₅₇Nb₄₀Cu₃, Ni₅₈Nb₃₉Cu₃, Ni₆₀Nb₃₇Cu₃, Ni₆₁Nb₃₆Cu₃, Ni₅₉Nb₃₇Cu₃Hf₁, Ni₅₉Nb₃₅Cu₃Hf₃, Ni₅₉Nb₃₇Cu₃Ti₁, Ni₅₉Nb₃₅Cu₃Ti₃, Ni₅₉Nb₃₃Cu₃Ti₅, Ni₆₁Nb₃₅Cu₁Ti₃, Ni₆₀Nb₃₅Cu₂Ti₃, Ni₅₆Nb₃₈Cu₃CO₃, Ni_{58.41}Nb_{37.62}Cu_{2.97}Al₁, Ni₅₉Nb₃₈Cu₂Fe₁, Ni₅₉Nb₃₆Cu₃Hf₂, Ni₅₉Nb_{35.92}Cu₃Hf_{2.8}, Ni₅₉Nb_{35.5}Cu₃Hf_{2.5}, Ni₅₉Nb_{34.5}Cu₃Hf_{3.5}, Ni₅₉Nb₃₃Cu₃Hf₅.

According to one embodiment, the part made of metallic glass has a critical thickness greater than 0.3 mm, preferably greater than 0.5 mm, more preferably greater than 1 mm.

Advantageously, the part made of metallic glass has an elastic limit, σel, greater than 2000 MPa, preferably greater than 2500 MPa, more preferably greater than 2700 MPa.

Preferably, the part made of metallic glass present a plastic contribution to deflection, fp, during a 3-point bending test in the direction of the thickness for a sample of thickness 0.5 mm, width 10 mm and length 15 mm, a length between supports of 10 mm and a crosshead speed of 0.005 mm/s, greater than 0 mm, preferably greater than 0.25 mm, more preferably greater than 0.60 mm, even more preferably greater than 1 mm.

According to one embodiment, the part made of metallic glass is such that the alloy has:
a glass transition temperature Tg less than 640° C., preferably less than 630° C. and/or
a difference ΔTx between the crystallization temperature Tx and the glass transition temperature Tg greater than 35, preferably greater than 45.

### BRIEF DESCRIPTION OF THE DRAWINGS

Other characteristics, details and advantages of the invention will appear on reading the detailed description below and on analyzing the appended drawings, in which:

FIG. 1 represents an X-ray diffraction analysis of an amorphous metallic alloy.

FIG. 2 represents an X-ray diffraction analysis of a partially amorphous metallic alloy.

FIG. 3 represents an X-ray diffraction analysis of a crystalline metallic alloy.

FIG. 4 represents a 3-point bending curve obtained during mechanical tests making it possible to evaluate the elastic limit, σel, and the plastic contribution to deflection, fp, of the samples made of amorphous metallic alloy.

FIG. 5 represents a micrograph carried out under the optical microscope of the sectional view of a sample having inclusions of zirconium oxide ZrO₂.

Some of the inclusions are indicated by arrows.

FIG. 6 represents a micrograph carried out under the optical microscope of the sectional view of a sample free of inclusion of zirconium oxides ZrO₂.

FIG. 7 illustrates the interest of the copper in the NiNbCu alloy system. The crystallization temperature Tx (in ° C.—gray circle) and the glass transition temperature Tg (in ° C.—black square) are represented as a function of the Cu content (atomic percentage) of the alloy.

FIG. 8 illustrates the effect of the Cu content (atomic percent) in the NiNbCu alloy system on the mechanical properties. The indicated mechanical properties are the elastic limit, σel (in MPa—black square) and the plastic contribution to deflection, fp (in mm—gray circle).

FIG. 9 illustrates the effect of the Nb content (atomic percent) in the NiNbCu alloy system on the mechanical properties. The indicated mechanical properties are the elastic limit, σel (in MPa—black square) and the plastic contribution to deflection, fp (in mm—gray circle).

### DESCRIPTION OF THE EMBODIMENTS

The drawings and the description below may not only serve to better understand the present invention but also contribute to its definition where appropriate.

In the foregoing, the following definitions should be clarified.

The terms “metallic glass” or “amorphous metallic alloy” or “AMA” mean here metals or metallic alloys which are not crystalline, that is to say whose atomic distribution is mainly random. Nevertheless, it is difficult to obtain a one hundred percent amorphous metallic alloy because most often a fraction of the material remains which is crystalline in nature. This definition may therefore be generalized to metals or metallic alloys which are partially crystalline and which therefore contain a fraction of crystals, as long as the amorphous fraction predominates compared to the crystalline fraction. The metallic glasses according to the present invention have an amorphous phase fraction greater than 50%, preferably greater than 60%, even more preferably greater than 70% and even greater than 80%.

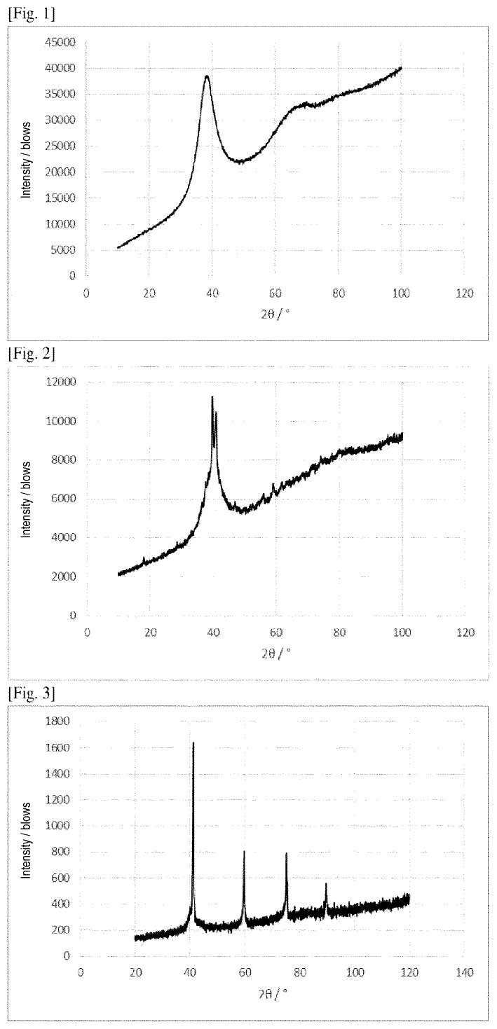

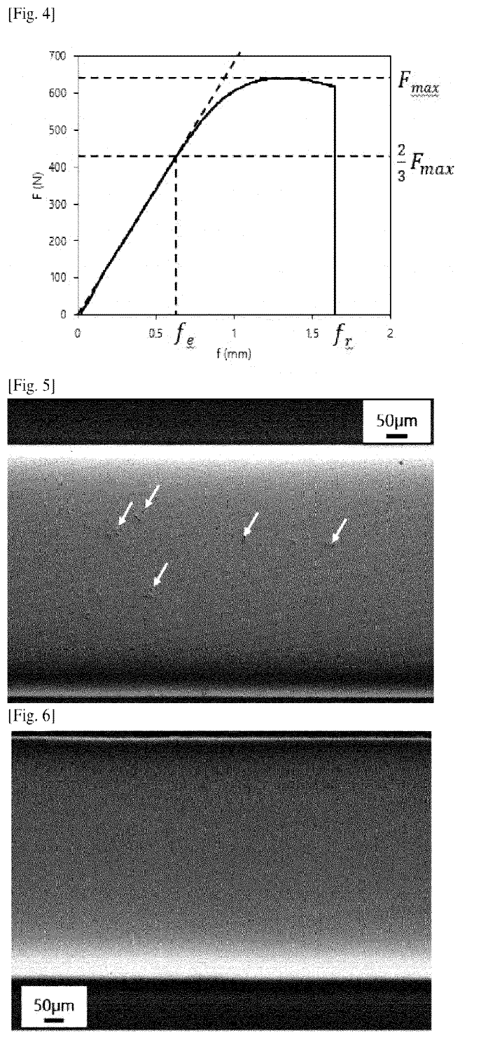

It is specified here that a metallurgical structure is called “totally amorphous” within the meaning of the present invention when an analysis by X-ray diffraction as described below does not reveal a crystallization peak as this is illustrated in [FIG. 1]. A metallurgical structure is called “partially amorphous” within the meaning of the present invention when an analysis by X-ray diffraction as described below highlights a few crystallization peaks as illustrated in [FIG. 2]. The term “amorphous” is used both for so-called “totally amorphous” alloys and for so-called “partially amorphous” alloys within the meaning of the invention. Such an evaluation of the amorphous character of a metallic alloy is detailed in the article Cheung et al., 2007 (Cheung et al. (2007) “Thermal and mechanical properties of Cu—Zr—Al bulk metallic glasses)” doi:10.1016/j.jallcom.2006.08.109). It makes it possible to made an average analysis on a surface and to overcome the few inevitable metallurgical defects, while analyzing only the crystals of significant size, that is to say greater than a few nanometers and/or in a significant quantity. FIGS. 1, 2 and 3 represent an XRD analysis as previously described. These figures show the intensity of the diffracted beam as a function of the angle between the incident beam and the diffracted beam. [FIG. 1] is an XRD analysis of a metallic alloy in the “totally amorphous” state, the amorphous fraction being very largely predominant compared to the crystalline fraction. [FIG. 2] is a similar analysis carried out on an alloy in the “partially amorphous” state, the amorphous fraction being predominant compared to the crystalline fraction. In this figure, we find the characteristic bump of the amorphous structures, but also with the presence of peaks. [FIG. 3] is a similar analysis carried out on a crystalline alloy, the crystalline fraction being predominant compared to the amorphous fraction. On [FIG. 3], the characteristic bump of AMAs is not present and the crystallinity peaks are clearly visible.

The terms “critical thickness” (denoted ec) of a specific amorphous metallic alloy mean the maximum thickness limit below which the metallic alloy has a “totally amorphous” metallurgical structure or beyond which it is not more possible to obtain a “totally amorphous” metallurgical structure, when the metallic alloy is cast from a liquid state and is subjected to a rapid cooling such that the transfer of the heat inside the metallic alloy is optimal. More specifically, the critical thickness is determined by successive casting plates of approximately 2 cm² and of different thicknesses, cast from the liquid state under the following conditions:
The alloy is melted at a temperature of TI+150° C. with TI, the liquidus temperature of the alloy (in ° C.);
The alloy is cast in a mold made of CuC1 type copper and is cooled to a maximum temperature of approximately twenty degrees Celsius (20° C.).
The alloy is elaborated and cast under an inert, high-purity atmosphere (e.g. under argon of quality 6.0) or under a secondary vacuum (pressure<10⁻⁴ mbar). The alloy is cast with a system allowing the application of a pressure differential to facilitate the casting of the alloy and to ensure an intimate contact between the alloy and the walls of the mold in order to ensure the rapid cooling of the alloy. The casting step may be carried out under a pressure of 20 MPa. This overpressure application system may be mechanical (piston) or gaseous (application of an overpressure).
After casting, the plates are cut in order to obtain a slice, that is to say a longitudinal section of the plate, with a thickness comprised between 0.3 and 2 millimeters.
The obtained slices are analyzed by X-ray diffraction to determine whether they have an amorphous or crystalline structure. The critical thickness is then determined as being the maximum thickness for which the structure is “totally amorphous” in the sense that the analysis by X-ray diffraction of the alloy does not reveal any crystallinity peak.

The terms “mirror finish” mean polishing the samples with SiC paper to grade P2400 followed by polishing with diamond suspension to a grain size of 1 μm.

According to the present description, the elastic limit, Gel, and the plastic contribution to deflection, fp, are evaluated as follows.

The mechanical tests are carried out on a mechanical testing machine DY34 (Adamel Lhomargy). These are 3-point bending tests in the direction of the thickness of the sample.

The parameters of the test are as follows:
Length between supports L=10 mm
Sample width b=10 mm
Sample thickness h=0.50 mm
Sample length I=15 mm
Crosshead speed v=0.005 mm/s

The 3-point bending curve has a first linear elastic part, then a plastic plateau (see [FIG. 3]).

The elastic limit, Gel, is calculated according to the following formula 1:

$$σ el = \frac{3 \times Fe \times L}{2 \times b \times {h}^{2}} \qquad [ Math 1 ]$$

where Fe is calculated according to the following formula 2:

$$Fe = 2 F max / 3 \qquad [ Math 2 ]$$

with
Fmax: the maximum force value recorded at the force plateau.

The plastic contribution to deflection, fp, is calculated according to the following formula 3:

$$fp = fr - fe \qquad [ Math 3 ]$$

with
fe is the deflection reached at a force level corresponding to the elastic limit, i.e. 2Fmax/3; and
fr is the deflection at break.

Each alloy has its own crystallization temperature Tx and glass transition temperature Tg. These temperatures are measured using a scanning calorimeter (DSC) at a rise rate of 20° C./min. The temperatures Tg and Tx are then extracted from the DSC curves.

For each alloy, it is thus possible to determine the difference ΔTx between the crystallization temperature Tx and the glass transition temperature Tg, i.e. ΔTx=Tx−Tg.

As indicated previously, the AMAs known until then, in particular those whose majority elements are nickel and niobium, have a compromise of mechanical properties, in particular for the properties such as their elastic limit and their plastic contribution to deflection, not optimized and/or less processability making their industrialization complex.

Against all expectations, the present inventors were able to remedy these problems and reference is now made to the amorphous metallic alloy, also referred to as “metallic glass”, which is the subject of the present invention.

The present metallic glass is thus formed from an alloy comprising:
(a-c-x) atomic percent of Ni, with a comprised between 54 and 72; and
(b-y) atomic percent of Nb, with b comprised between 35 and 44; and
c atomic percent of Cu, with c from 0.05 to 9; and
x atomic percent of at least one element chosen from: Co, Fe, Ag, Mn, Pd, Au, Ir, Os, Pt, Re, Rh, Ru and Tc, preferably chosen from: Co, Fe, Ag, Mn and Pd, more preferably chosen from: Co and Fe, with x from 0 to 20; and
y atomic percent of at least one element chosen from: Hf, Ta, Ti, Cr, Mo, Sc, V, W and Y, preferably chosen from: Hf, Ta and Ti, more preferably chosen from: Hf and Ti, with y from 0 to 20; and
z atomic percent of at least one element chosen from: B, Si, Al, Sn, Ca, Ga, In, Mg and Zn, preferably chosen from: B, Si and Al, more preferably Al, with z from 0 to 10; and
at most 3 atomic percent of Zr; and
other elements not more than 0.1% by weight each and 0.5% by weight in total.

The Ni content of the alloy, in atomic percentage, corresponds to the formula (a-c-x) with a comprised between 54 and 72, preferably from 58 to 66, more preferably from 60 to 64, even more preferably from 61 to 63. The number c corresponds, in atomic percentage, to the Cu content of the alloy while the number x, in atomic percentage, corresponds to the content of at least one element chosen from: Co, Fe, Ag, Mn, Pd, Au, Ir, Os, Pt, Re, Rh, Ru and Tc.

The Nb content of the alloy, in atomic percentage, corresponds to the formula (b-y) with b comprised between 35 and 44, preferably from 35 to 42, more preferably from 36 to 41, and even more preferably from 37 to 39. The number y, in atomic percentage, corresponds to the content of at least one element chosen from: Hf, Ta, Ti, Cr, Mo, Sc, V, Wand Y.

As demonstrated in particular in Example 4, such a Ni and Nb content makes it possible to obtain an alloy whose amorphous phase predominates compared to the crystalline phase and which has excellent mechanical properties such as in particular an excellent compromise of properties between the elastic limit and the plastic contribution to deflection.

The Cu content c of the alloy, in atomic percentage, is from 0.05 to 9, preferably from 0.05 to 8, more preferably from 0.5 to 6, and even more preferably from 0.5 to 5 or from 1 to 4.

As demonstrated in particular in Examples 2 and 3, such a Cu content makes it possible to obtain an alloy whose amorphous phase predominates compared to the crystalline phase, having excellent mechanical properties such as in particular an excellent compromise of properties between the limit elasticity and the plastic contribution to deflection, as well as an excellent processability essential for the industrialization of the parts made of high-speed AMAs and a good thermal stability.

The alloy may further comprise at least one element chosen from: Co, Fe, Ag, Mn, Pd, Au, Ir, Os, Pt, Re, Rh, Ru and Tc, preferably at least one element chosen from: Co, Fe, Ag, Mn and Pd and more preferably chosen from: Co and Fe. The total content x of said element(s), in atomic percentage, is from 0 to 20; preferably from 0.5 to 10, more preferably from 1 to 6, more preferably from 1 to 5 and even more preferably from 1 to 3. The substitution of part of the Ni content by at least one of these elements, is capable of improving at least one of the mechanical properties of the present alloy.

The alloy may further comprise at least one element chosen from: Hf, Ta, Ti, Cr, Mo, Sc, V, W and Y, preferably chosen from Hf, Ta and Ti and more preferably chosen from: Hf and Ti. The total content y of said element(s), in atomic percentage, is from 0 to 20; preferably from 0.5 to 10, more preferably from 1 to 8, more preferably from 1 to 5 and even more preferably from 1 to 3. The substitution of part of the Nb content by at least one of these elements, is capable of improving at least one of the mechanical properties of the present alloy.

The alloy may also comprise at least one element chosen from: B, Si, Al, Sn, Ca, Ga, In, Mg and Zn, preferably chosen from: B, Si, and Al, more preferably Al. The total content z of said element(s), in atomic percentage, is from 0 to 10; preferably from 0 to 8, more preferably from 0.5 to 8, and even more preferably from 1 to 5 and even more preferably from 1 to 3. The addition of at least one of these elements is capable of improving at least one of the mechanical properties of the present alloy.

The Zr content of the alloy, in atomic percentage, is at most 3, preferably less than 3, more preferably less than 2, even more preferably less than 1, or even less 0.5 or even less than 0.1. The alloy may just as well be free of zirconium, that is to say it comprises, in weight percent, less than 0.05, preferably less than 0.01, more preferably less than 0.001 of zirconium.

As demonstrated in Example 1, such a Zr content makes it possible to obtain an alloy without inclusion, in particular free of zirconium oxide particles. In addition, the very low Zr content or the absence of Zr in the alloy makes it possible to preserve the molds used during the method for manufacturing the parts made of alloy according to the invention.

The alloy may also comprise other elements, also referred to as “residual impurities”, such as, oxygen, carbon and/or phosphorus. These residual impurities may also be any other element(s) not added voluntarily during the mixing of metals to obtain the alloy blank. The impurity content of the alloy, in weight percent, is not more than 0.1 each and not more than 0.5 in total. More preferably, this content is, in weight percent, at most 0.05 each and at most 0.2% by weight in total. Preferably, the alloy comprises less than 250 ppm (parts per million) by weight, more preferably less than 200 ppm by weight and even more preferably less than 150 ppm by weight of each of these impurities.

According to a preferred embodiment, the amorphous metallic alloy is selected from: Ni₆₁Nb₃₈Cu₁, Ni₆₀Nb₃₈Cu₂, Ni₅₉Nb₃₈Cu₃, Ni₅₈Nb₃₈Cu₄, Ni₅₆Nb₃₈Cu₆, Ni₅₄Nb₃₈Cu₈, Ni₅₅Nb₄₂Cu₃, Ni₅₇Nb₄₀Cu₃, Ni₅₈Nb₃₉Cu₃, Ni₆₀Nb₃₇Cu₃, Ni₆₁Nb₃₆Cu₃, Ni₅₉Nb₃₇Cu₃Hf₁, Ni₅₉Nb₃₅Cu₃Hf₃, Ni₅₉Nb₃₇Cu₃Ti₁, Ni₅₉Nb₃₅Cu₃Ti₃, Ni₅₉Nb₃₃Cu₃Ti₅, Ni₆₁Nb₃₅Cu₁Ti₃, Ni₆₀Nb₃₅Cu₂Ti₃, Ni₅₆Nb₃₈Cu₃CO₃, Ni_{58.41}Nb_{37.62}Cu_{2.97}Al₁, Ni₅₉Nb₃₈Cu₂Fe₁, Ni₅₉Nb₃₆Cu₃Hf₂, Ni₅₉Nb_{35.92}Cu₃Hf_{2.8}, Ni₅₉Nb_{35.5}Cu₃Hf_{2.5}, Ni₅₉Nb_{34.5}Cu₃Hf_{3.5}, Ni₅₉Nb₃₃Cu₃Hf₅.

A metallic alloy as described above advantageously makes it possible to obtain parts made of amorphous metallic alloy having a critical thickness, ec, greater than 0.3 mm, preferably greater than 0.5 mm, more preferably greater than 1 mm.

According to a preferred embodiment compatible with the previous one, such a metallic alloy also makes it possible to obtain parts made of amorphous metallic alloy having an elastic limit, σel, greater than 2000 MPa, preferably greater than 2500 MPa, more preferably greater than 2700 MPa.

The parts made of amorphous metallic alloy according to the invention advantageously have a plastic contribution to deflection, fp, evaluated during a 3-point bending test in the direction of the thickness for a sample of thickness 0.5 mm, width 10 mm and length 15 mm, a length between supports of 10 mm and a crosshead speed of 0.005 mm/s, greater than 0 mm, preferably greater than 0.25 mm, more preferably greater than 0.60 mm, again more preferably greater than 1 mm.

According to a preferred embodiment, the parts made of amorphous metallic alloy according to the invention have:
a glass transition temperature Tg less than 640° C., preferably less than 630° C. and/or
a difference ΔTx between the crystallization temperature Tx and the glass transition temperature Tg greater than 35, preferably greater than 45.

An alloy whose glass transition temperature Tg is low has a better processability essential for the industrialization of the parts made of high-speed AMAs. Moreover, the higher is the difference ΔTx between the crystallization temperature Tx and the glass transition temperature Tg of an alloy, the more the alloy has a good thermal stability.

The invention also relates to a method for manufacturing a part made of amorphous metallic alloy comprising the following steps:
melting a mixture of metals to obtain an alloy, then
casting the obtained alloy in a mold, then
cooling the cast alloy with a cooling rate greater than a critical crystallization rate of the alloy, to obtain an amorphous alloy preform or a part made of amorphous alloy, then
optionally thinning the obtained preform to obtain a thinned amorphous alloy preform or a part made of amorphous alloy, then
optionally machining the amorphous alloy preform, possibly thinned, preferably by laser cutting, electro-erosion, turning and/or thermoforming, to obtain a part made of amorphous alloy according to a predetermined geometry, then
optionally carrying out a step of finishing the part made of amorphous alloy.

Advantageously, the molten metallic alloy may be shaped to obtain a blank. The blank is then melted, cast and cooled to obtain an amorphous alloy preform or a part made of amorphous alloy.

### INDUSTRIAL APPLICATION

The invention may find application in particular for obtaining parts made of amorphous metallic alloy such as timepieces or parts for medical use.

Preferably, the parts made of metallic glass according to the invention are microcomponents whose dimensions, or, at least, at least one of their dimensions, is in the range of a few hundred to a few tens of micrometers.

The invention is not limited to the only description above and/or to the examples 1 to 5 described below, but it encompasses all the variants that those skilled in the art may consider in the context of the protection sought.

### EXAMPLES

### Example 1: Formation of Oxides

Four different compositions of metallic glass alloys, detailed in Table 1, were studied.

The primary alloys were produced by arc melting (T>2500° C.) of bulk fragments of high purity (>99.9%) base elements under argon atmosphere using a Ti getter for the detection of any trace of harmful contamination. Each primary alloy has been melted at least five times to ensure a high chemical homogeneity quality. The alloy was injected into a mold to obtain a sample in the form of a plate with a thickness of <1 mm. This thickness, less than the critical thickness, ensures that the obtained structure is amorphous. For all the samples, the amorphous fraction was predominant compared to the crystalline fraction.

The presence of zirconium oxides was evaluated as follows. A metallographic cut was carried out on the plate: the plate was cut longitudinally and polished to a mirror finish. The polished surface was observed under the optical microscope at a magnification at least equal to ×100. If the observed structure has inclusions as on [FIG. 5](a few are indicated by arrows), then the composition of these inclusions was verified by energy dispersive X-ray spectroscopy (EDS). The revealed composition was systematically that of zirconium oxides ZrO₂. An index of 1 (“presence of zirconium oxides”) was assigned to the alloys having inclusions. On the other hand, if the structure observed under the optical microscope does not have any inclusion, as on [FIG. 6], then an index 0 (“absence of zirconium oxides”) is assigned to the analyzed alloy.

TABLE 1

| Composition | Presence |
|---|---|
| (atomic percent) | of oxides |
| Ni₆₂Nb₃₃Zr₅ | 1 |
| Ni₆₀Cu₂Nb₃₃Zr₅ | 1 |
| Ni₆₀Cu₂Nb₃₈ | 0 |
| Ni₆₂Nb₃₈ | 0 |

### Example 2: Interest of Cu in the NiNb Alloy System

Five different compositions of alloys to obtain a metallic glass were studied. The compositions of these alloys are indicated in Table 2.

The samples were obtained according to the same protocol as that of Example 1. For all the samples, except Ni₅₂Nb₃₈Cu₁₀, the amorphous fraction was predominant compared to the crystalline fraction for a thickness of 0.5 mm.

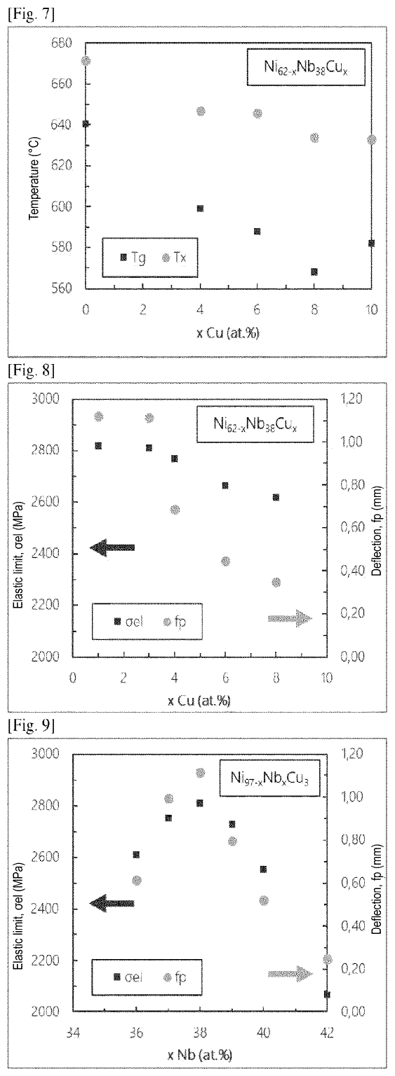

The crystallization temperature Tx and the glass transition temperature Tg of the alloys, as well as the difference ΔTx between the crystallization temperature Tx and the glass transition temperature Tg, evaluated according to the protocol described in the present description, are reported in Table 2 and illustrated in [FIG. 7].

TABLE 2

| Composition | Tg | Tx | ΔTx |
|---|---|---|---|
| (atomic percent) | (° C.) | (° C.) | (° C.) |
| Ni₆₂Nb₃₈ | 641 | 672 | 31 |
| Ni₅₈Nb₃₈Cu₄ | 599 | 647 | 48 |
| Ni₅₆Nb₃₈Cu₆ | 588 | 646 | 58 |
| Ni₅₄Nb₃₈Cu₈ | 568 | 634 | 66 |
| Ni₅₂Nb₃₈Cu₁₀ | 582 | 633 | 51 |

An alloy whose glass transition temperature Tg is low has a better processability essential for the industrialization of parts made of high-speed AMAs. Moreover, the higher the difference ΔTx between the crystallization temperature Tx and the glass transition temperature Tg of an alloy, the more the alloy has a good thermal stability.

### Example 3: Cu Content of the Amorphous Metallic Alloy

Six different compositions of alloys to obtain a metallic glass were studied. The compositions of these alloys are indicated in Table 3.

The samples were obtained according to the same protocol as that of Example 1. For all the samples, with the exception of that made of Ni₅₂Nb₃₈Cu₁₀ alloy, the amorphous fraction was predominant compared to the crystalline fraction for a thickness of 0.5 mm.

The mechanical properties of each sample are indicated in Table 3 and illustrated in [FIG. 8]. The values of the elastic limit were determined thanks to mechanical tests carried out in 3-point bending. At least 3 tests were carried out for each composition in order to ensure a good reproducibility of the results.

TABLE 3

| | Elastic | Plastic contribution |
|---|---|---|
| Composition | limit | to deflection |
| (atomic percent) | (MPa) | (mm) |
| Ni₆₁Nb₃₈Cu₁ | 2820 | 1.12 |
| Ni₅₉Nb₃₈Cu₃ | 2809 | 1.11 |
| Ni₅₈Nb₃₈Cu₄ | 2766 | 0.69 |
| Ni₅₆Nb₃₈Cu₆ | 2664 | 0.45 |
| Ni₅₄Nb₃₈Cu₈ | 2618 | 0.35 |
| Ni₅₂Nb₃₈Cu₁₀ | nm* | nm* |

*nm = “Not measured”, the measurement could not be performed due to the breakage of the samples during the test.

### Example 4: Ni/Nb Content of the Amorphous Metallic Alloy

Seven different compositions of alloys were studied. The compositions of these alloys are indicated in Table 4.

The samples were obtained according to the same protocol as that of Example 1. For all the samples, with the exception of that made of Ni₆₃Nb₃₄Cu₃ alloy, the amorphous fraction was predominant compared to the crystalline fraction for a thickness of 0.5 mm.

The mechanical properties of each sample are indicated in Table 4 and illustrated in [FIG. 9].

TABLE 4

| | | Plastic |
|---|---|---|
| Composition | | contribution to |
| (atomic | Elastic limit | deflection |
| percent) | (MPa) | (mm) |
| Ni₅₅Nb₄₂Cu₃ | 2069 | 0.25 |
| Ni₅₇Nb₄₀Cu₃ | 2552 | 0.52 |
| Ni₅₈Nb₃₉Cu₃ | 2728 | 0.80 |
| Ni₅₉Nb₃₈Cu₃ | 2809 | 1.11 |
| Ni₆₀Nb₃₇Cu₃ | 2752 | 0.99 |
| Ni₆₁Nb₃₆Cu₃ | 2609 | 0.62 |
| Ni₆₃Nb₃₄Cu₃ | 1142 | 0.00 |

### Example 5: Quaternary NiNbCu Amorphous Metallic Alloy

Fifteen different compositions of quaternary alloy were studied. Ten of these compositions are indicated in Table 5. The compositions Ni₅₉Nb₃₆Cu₃Hf₂, Ni₅₉Nb_{35.92}Cu₃Hf_{2.8}, Ni₅₉Nb_{35.5}Cu₃Hf_{2.5}, Ni₅₉Nb_{34.5}Cu₃Hf_{3.5}, Ni₅₉Nb₃₃Cu₃Hf₅ have also been studied.

The samples were obtained according to the same protocol as that of Example 1. For all the samples, the amorphous fraction was predominant compared to the crystalline fraction for a thickness of 0.5 mm.

The mechanical properties of each of the first ten compositions of alloys are indicated in Table 5.

TABLE 5

| | | Plastic |
|---|---|---|
| | | contribution to |
| Composition | Elastic limit | deflection |
| (atomic percent) | (MPa) | (mm) |
| Ni₅₉Nb₃₇Cu₃Hf₁ | 2749 | 0.88 |
| Ni₅₉Nb₃₅Cu₃Hf₃ | 2855 | 0.88 |
| Ni₅₉Nb₃₇Cu₃Ti₁ | 2818 | 0.81 |
| Ni₅₉Nb₃₅Cu₃Ti₃ | 2707 | 0.90 |
| Ni₅₉Nb₃₃Cu₃Ti₅ | 2800 | 1.01 |
| Ni₆₁Nb₃₅Cu₁Ti₃ | 2717 | 1.10 |
| Ni₆₀Nb₃₅Cu₂Ti₃ | 2695 | 0.71 |
| Ni₅₆Nb₃₈Cu₃Co₃ | 2690 | 0.79 |
| Ni_{58.41}Nb_{37.62}CU_{2.97}Al₁ | 2906 | 0.86 |
| Ni₅₉Nb₃₈Cu₂Fe₁ | 2898 | 0.85 |

The samples Ni₅₉Nb₃₆Cu₃Hf₂, Ni₅₉Nb_{35.92}Cu₃Hf_{2.8}, Ni₅₉Nb_{35.5}Cu₃Hf_{2.5}, Ni₅₉Nb_{34.5}Cu₃Hf_{3.5}, Ni₅₉Nb₃₃Cu₃Hf₅ all also have an
elastic limit, σel, greater than 2500 MPa and a plastic contribution to deflection, fp, greater than 0.60 mm.

1. A metallic glass formed from an alloy comprising:
(a-c-x) atomic percent of Ni, with a comprised between 54 and 72; and
(b-y) atomic percent of Nb, with b comprised between 35 and 44; and
c atomic percent of Cu, with c from 0.05 to 9; and
x atomic percent of at least one element chosen from: Co, Fe, Ag, Mn, Pd, Au, Ir, Os, Pt, Re, Rh, Ru and Tc, with x from 0 to 20; and
y atomic percent of at least one element chosen from: Hf, Ta, Ti, Cr, Mo, Sc, V, W and Y, with y from 0 to 20; and
z atomic percent of at least one element chosen from: B, Si, Al, Sn, Ca, Ga, In, Mg and Zn, with z from 0 to 10; and
not more than 3 atomic percent of Zr; and
other elements not more than 0.1% by weight each and not more than 0.5% by weight in total.

2. The metallic glass according to claim 1 comprising (a-c-x) atomic percent of Ni, with a from 58 to 66.

3. The Metallic glass according to claim 1 comprising (b-y) atomic percent of Nb, with b from 35 42.

4. The metallic glass according to claim 1 comprising c atomic percent of Cu, with c from 0.05 to 8.

5. The metallic glass according to claim 1 comprising x atomic percent of at least one element chosen from Co, Fe, Ag, Mn, Pd, Au, Ir, Os, Pt, Re, Rh, Ru and Tc, with x from 0.5 to 10.

6. The metallic glass according to claim 1 comprising y atomic percent of at least one element chosen from: Hf, Ta, Ti, Cr, Mo, Sc, V, W and Y with y from 0.5 to 10.

7. The metallic glass according to claim 1 comprising z atomic percent of at least one element chosen from: B, Si, Al, Sn, Ca, Ga, In, Mg and Zn, with z from 0 to 8.

8. The metallic glass according to claim 1 comprising less than 3 atomic percent of Zr.

9. The metallic glass according to claim 1 selected from: Ni₆₁Nb₃₈Cu₁, Ni₆₀Nb₃₈Cu₂, Ni₅₉Nb₃₈Cu₃, Ni₅₈Nb₃₈Cu₄, Ni₅₆Nb₃₈Cu₆, Ni₅₄Nb₃₈Cu₂, Ni₅₅Nb₄₂Cu₃, Ni₅₇Nb₄₀Cu₃, Ni₅₅Nb₃₉Cu₃, Ni₆₀Nb₃₇Cu₃, Ni₆₁Nb₃₆Cu₃, Ni₅₉Nb₃₇Cu₃Hf₁, Ni₅₉Nb₃₅Cu₃Hf₃, Ni₅₉Nb₃₇Cu₃Ti₁, Ni₅₉Nb₃₅Cu₃Ti₃, Ni₅₉Nb₃₃Cu₃Ti₅, Ni₆₁Nb₃₅Cu₁Ti₃, Ni₆₀Nb₃₅Cu₂Ti₃, Ni₅₆Nb₃₈Cu₃Co₃, Ni_{58.41}Nb_{37.62}Cu_{2.97}Al₁, Ni₅₉Nb₃₈Cu₂Fe₁, Ni₅₉Nb₃₆Cu₃Hf₂, Ni₅₉Nb_{35.92}Cu₃Hf_{2.08}, Ni₅₉Nb_{35.5}Cu₃Hf_{2.5}, Ni₅₉Nb_{34.5}Cu₃Hf_{3.5}, Ni₅₉Nb₃₃Cu₃Hf₅.

10. A part made of metallic glass according to claim 1 having a critical thickness greater than 0.3 mm.

11. The part made of metallic glass according to claim 1 having an elastic limit, σel, greater than 2000 MPa.

12. The part made of metallic glass according to claim 1 having a plastic contribution to deflection, fp, in a 3-point bending test in the direction of the thickness for a sample of thickness 0.5 mm, width 10 mm and length 15 mm, a length between supports of 10 mm and a crosshead speed of 0.005 mm/s, greater than 0 mm.

13. The part made of metallic glass according to claim 1, such that the alloy has:
a glass transition temperature Tg less than 640° C.; and/or
a difference ΔTx between the crystallization temperature Tx and the glass transition temperature Tg greater than 35.

14. The part made of metallic glass according to claim 1, such that the part is a timepiece or a part for medical use.

15. A method for manufacturing a part made of metallic glass according to claim 1 comprising the following steps:
melting a mixture of metals to obtain an alloy,
casting the obtained alloy in a mold, and
cooling the cast alloy with a cooling rate greater than a critical crystallization rate of the alloy, to obtain an amorphous alloy preform or a part made of amorphous alloy,
optionally, thinning the obtained preform to obtain a thinned amorphous alloy preform or a part made of amorphous alloy,
optionally, machining the amorphous alloy preform to obtain a part made of amorphous alloy according to a predetermined geometry,
optionally, carrying out a step of finishing the part made of amorphous alloy.
